(19) United States
(12) Patent Application Publication
(10) Pub. No.: US 2014/0359413 A1
(43) Pub. Date: Dec. 4, 2014

(54) APPARATUSES AND METHODS FOR WEBPAGE CONTENT PROCESSING

(71) Applicant: Tencent Technology (Shenzhen) Company Limited, Shenzhen (CN)

(72) Inventor: Fei SONG, Shenzhen (CN)

(73) Assignee: Tencent Technology (Shenzhen) Company Limited, Shenzhen (CN)

(21) Appl. No.: 14/326,973

(22) Filed: Jul. 9, 2014

Related U.S. Application Data
(63) Continuation of application No. PCT/CN2014/072235, filed on Feb. 19, 2014.

(30) Foreign Application Priority Data
May 28, 2013 (CN) 201310204185.3

(51) Int. Cl. G06F 17/30

(52) U.S. Cl. CPC G06F 17/30864; G06F 17/3089
USPC 715/205

(57) ABSTRACT

A present disclosure relates to a method for processing webpage content. The method may comprise, through one or more processor of a terminal device, opening a target webpage on the terminal device; obtaining a target extraction instruction; extracting a title and text content from the target webpage according to the extraction instruction; and displaying the extracted title and text content on the terminal device.

### PRIORITY STATEMENT

This application is a continuation of International Application No. PCT/CN2014/072235, filed on Feb. 19, 2014, in the State Intellectual Property Office of the People's Republic of China, which claims the priority benefit of Chinese Patent Application No. 201310204185.3 filed on May 28, 2013, the disclosures of which are incorporated herein in their entirety by reference.

### BACKGROUND OF THE INVENTION

1. Field of the Invention

The present invention generally relates to the field of computer technologies. Specifically, the present invention relates to apparatuses and methods for webpage content processing.

2. Description of the Related Art

Generally, when a user browses a webpage and reads an article on the webpage, the user only pays attention to title and text content of the article. However, in addition to displaying title and text content of the article, the webpage often includes other content not related to the text, such as advertisements, photos, website mapping information, etc. Using a news webpage as an example, in addition to the title and text content of a news, contents to which other users may not pay attention, such as a releasing time of the news, links of other recommended articles, top headlines, remark information, and advertisements, etc., are further included. If all these contents are loaded and displayed, it can be inconvenient for a user to read the article, especially when the webpage is browsed by using a mobile terminal device, such as a mobile phone, which usually has a small screen. The contents not related to the content of the article occupy the limited screen space and interfere normal browsing of the title and text content.

### SUMMARY OF THE INVENTION

According to an aspect of the present disclosure, a method may relate to webpage content processing. Through at least one processor of a terminal device, the method may comprise: opening a target webpage on the terminal device, wherein the target page includes a plurality of title content blocks and a plurality of text content blocks; obtaining a target extraction instruction, wherein the target extraction instruction is configured to match with a uniform resource locator (URL) address of the target webpage, and includes a path description of the plurality of title content blocks and a path description of the plurality of text content blocks of the target webpage configured to direct the at least one processor to extract content of the target webpage. The method may also comprise extracting a title and text content from the target webpage according to the path description of the title content block and the path description of the text content block; and displaying the extracted title and text content on the terminal device.

According to another aspect of the present disclosure, an apparatus may comprise at least one non-transitory processor-readable storage medium and at least one processor in communication with the at least one storage medium. The at least one storage medium may include at least one set of instructions for webpage content processing. The at least one processor may be configured to execute the at least one set of instructions to: open a target webpage on the terminal device, wherein the target page includes a plurality of title content blocks and a plurality of text content blocks; obtain a target extraction instruction, wherein the target extraction instruction is configured to match with a uniform resource locator (URL) address of the target webpage, and includes a path description of the plurality of title content blocks and a path description of the plurality of text content blocks of the target webpage configured to direct the at least one processor to extract content of the target webpage. The at least one storage medium may also be configured to extract a title and text content from the target webpage according to the path description of the title content block and the path description of the text content block; and display the extracted title and text content on the terminal device.

These and other advantages, aspects, and novel features of the present disclosure, as well as details of illustrated embodiments thereof, will be more fully understood from the following description and drawings.

### BRIEF DESCRIPTION OF THE DRAWINGS

FIG. 1 is a flowchart of a webpage content processing method according to example embodiments of the present disclosure;

FIG. 2 is a flowchart of a method for obtaining an extraction instruction matching a URL address of a target webpage according to the example embodiments of the present disclosure;

FIG. 3 is a flowchart of a method for extracting title and text contents in a target web page according to the example embodiments of the present disclosure;

FIG. 4A is an example of a target webpage before content extraction;

FIG. 4B is an example of the target webpage shown in FIG. 4A after extraction;

FIG. 5 is a flowchart of a method for removing a dust on a target webpage according to the example embodiments of the present disclosure;

FIG. 6A is an example of a target webpage before content extraction;

FIG. 6B is an example of the target webpage shown in FIG. 6A after extraction;

FIG. 7 is a flowchart of a method for extracting a next page link in a target webpage according to the example embodiments of the present disclosure;

FIG. 8 is an example of a next page block according to the example embodiments of the present disclosure;

FIG. 9 is a block diagram illustrating a terminal device for executing a webpage processing method according to the example embodiments of the present disclosure;

FIG. 10 is a block diagram illustrating an extraction instruction obtaining module in FIG. 9;

FIG. 11 is a block diagram illustrating an extraction instruction matching module in FIG. 9;

FIG. 12 is a block diagram illustrating a title and text extraction module in FIG. 9;

FIG. 13 is a block diagram illustrating a terminal device for executing a webpage processing method according to the example embodiments of the present disclosure;

FIG. 14 is a block diagram illustrating a terminal device for executing a webpage processing method according to the example embodiments of the present disclosure;

FIG. 15 is a block diagram illustrating a next page link extraction module in FIG. 14;

FIG. 16 is a block diagram illustrating a second next page link determining module in FIG. 14;

FIG. 17 is block diagram illustrating another second next page link determining module in FIG. 14; and

FIG. 18 is a schematic diagram of a terminal device according to the example embodiments of the present disclosure.

### DETAILED DESCRIPTION OF THE PREFERRED EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

FIG. 18 illustrates a structural diagram of a terminal device 1800 according to the example embodiments of the present disclosure. The terminal device 1800 may be implemented as systems and/or to operate methods disclosed in the present disclosure. The terminal device 1800 may be, but is not limited to, a personal computer, a personal digital assistant, a laptop portable computer, a smart phone, a tablet computer, an MP3 player, and an MP4 player.

The terminal device 1800 may include an RF (Radio Frequency) circuit 1110, one or more than one memory unit(s) 1120 of computer-readable memory media, an input unit 1130, a display unit 1140, a sensor 1150, an audio circuit 1160, a WiFi (wireless fidelity) module 1170, at least one processor 1180, and a power supply 1190. Those of ordinary skill in the art may understand that the structure of the terminal device 1800 shown in FIG. 18 does not constitute restrictions on the terminal device 1800. Compared with what may be shown in the figure, more or fewer components may be included, or certain components may be combined, or components may be arranged differently.

The RF circuit 1110 may be configured to receive and transmit signals during the course of receiving and transmitting information and/or phone conversation. Specifically, after the RF circuit 1110 receives downlink information from a base station, it may hand off the downlink information to the processor 1180 for processing. Additionally, the RF circuit 1110 may transmit uplink data to the base station. Generally, the RF circuit 1110 may include, but may be not limited to, an antenna, at least one amplifier, a tuner, one or multiple oscillators, a subscriber identification module (SIM) card, a transceiver, a coupler, an LNA (Low Noise Amplifier), and a duplexer. The RF circuit 1110 may also communicate with a network and/or other devices via wireless communication. The wireless communication may use any communication standards or protocols available or one of ordinary skill in the art may perceive at the time of the present disclosure. For example, the wireless communication may include, but not limited to, GSM (Global System of Mobile communication), GPRS (General Packet Radio Service), CDMA (Code Division Multiple Access), WCDMA (Wideband Code Division Multiple Access), LTE (Long Term Evolution), email, and SMS (Short Messaging Service).

The memory unit 1120 may be configured to store software programs and/or modules. The software programs and/or modules may be sets of instructions to be executed by the processor 1180. The processor 1180 may execute various functional applications and data processing by running the software programs and modules stored in the memory unit 1120. The memory unit 1120 may include a program memory area and a data memory area, wherein the program memory area may store the operating system and at least one functionally required application program (such as the audio playback function and image playback function); the data memory area may store data (such as audio data and phone book) created according to the use of the terminal device 1800. Moreover, the memory unit 1120 may include high-speed random-access memory and may further include non-volatile memory, such as at least one disk memory device, flash device, or other volatile solid-state memory devices. Accordingly, the memory unit 1120 may further include a memory controller to provide the processor 1180 and the input unit 1130 with access to the memory unit 1120.

The input unit 1130 may be configured to receive information, such as numbers or characters, and create input of signals from keyboards, touch screens, mice, joysticks, optical or track balls, which are related to user configuration and function control. Specifically, the input unit 1130 may include a touch-sensitive surface 1131 and other input devices 1132. The touch-sensitive surface 1131, also called a touch screen or a touch pad, may collect touch operations by a user on or close to it (e.g., touch operations on the touch-sensitive surface 1131 or close to the touch-sensitive surface 1131 by the user using a finger, a stylus, and/or any other appropriate object or attachment) and drive corresponding connecting devices according to preset programs. The touch-sensitive surface 1131 may include two portions, a touch detection device and a touch controller. The touch detection device may be configured to detect the touch location by the user and detect the signal brought by the touch operation, and then transmit the signal to the touch controller. The touch controller may be configured to receive the touch information from the touch detection device, convert the touch information into touch point coordinates information of the place where the touch screen may be contacted, and then send the touch point coordinates information to the processor 1180. The touch controller may also receive commands sent by the processor 1180 for execution. Moreover, the touch-sensitive surface 1131 may be realized by adopting multiple types of touch-sensitive surfaces, such as resistive, capacitive, infrared, and/or surface acoustic sound wave surfaces. Besides the touch-sensitive surface 1131, the input unit 1130 may further include other input devices 1132, such as the input devices 1132 may also include, but not limited to, one or multiple types of physical keyboards, functional keys (for example, volume control buttons and switch buttons), trackballs, mice, and/or joysticks.

The display unit 1140 may be configured to display information input by the user, provided to the user, and various graphical user interfaces on the terminal device 1800. These graphical user interfaces may be composed of graphics, texts, icons, videos, and/or combinations thereof. The display unit 1140 may include a display panel 1141. The display panel 1141 may be in a form of an LCD (Liquid Crystal Display), an OLED (Organic Light-Emitting Diode), or any other form available at the time of the present disclosure or one of ordinary skill in the art would have perceived at the time of the present disclosure. Furthermore, the touch-sensitive surface 1131 may cover the display panel 1141. After the touch-sensitive surface 1131 detects touch operations on it or nearby, it may transmit signals of the touch operations to the processor 1180 to determine the type of the touch event. Afterwards, according to the type of the touch event, the processor 1180 may provide corresponding visual output on the display panel 1141. In FIG. 18, the touch-sensitive surface 1131 and the display panel 1141 realize the input and output functions as two independent components. Alternatively, the touch-sensitive surface 1131 and the display panel 1141 may be integrated to realize the input and output functions.

The terminal device 1800 may further include at least one type of sensor 1150, for example, an optical sensor, a motion sensor, and other sensors. An optical sensor may include an environmental optical sensor and a proximity sensor, wherein the environmental optical sensor may adjust the brightness of the display panel 1141 according to the brightness of the environment, and the proximity sensor may turn off the display panel 1141 and/or back light when the terminal device 1800 may be moved close an ear of the user. As a type of motion sensor, a gravity acceleration sensor may detect the magnitude of acceleration in various directions (normally three axes) and may detect the magnitude of gravity and direction when it may be stationary. The gravity acceleration sensor may be used in applications of recognizing the attitude of the terminal device 1800 (e.g., switching screen orientation, related games, and magnetometer calibration) and functions related to vibration recognition (e.g., pedometers and tapping); the terminal device 1800 may also be configured with a gyroscope, barometer, hygrometer, thermometer, infrared sensor, and other sensors.

An audio circuit 1160, a speaker 1161, and a microphone 1162 may provide audio interfaces between the user and the terminal device 1800. The audio circuit 1160 may transmit the electric signals, which are converted from the received audio data, to the speaker 1161, and the speaker 1161 may convert them into the output of sound signals; on the other hand, the microphone 1162 may convert the collected sound signals into electric signals, which may be converted into audio data after they are received by the audio circuit 1160; after the audio data may be output to the processor 1180 for processing, it may be transmitted via the RF circuit 1110 to, for example, another terminal device; or the audio data may be output to the memory unit 1120 for further processing. The audio circuit 1160 may further include an earplug jack to provide communication between earplugs and the terminal device 1800.

WiFi may be a short-distance wireless transmission technology. Via the WiFi module 1170, the terminal device 1800 may help users receive and send emails, browse web pages, and visit streaming media. The WiFi module 1170 may provide the user with wireless broadband Internet access.

The processor 1180 may be the control center of the terminal device 1800. The processor 1180 may connect to various parts of the entire terminal device 1800 utilizing various interfaces and circuits. The processor 1180 may conduct overall monitoring of the terminal device 1800 by running or executing the software programs and/or modules stored in the memory unit 1120, calling the data stored in the memory unit 1120, and executing various functions and processing data of the terminal device 1800. The processor 1180 may include one or multiple processing core(s). The processor 1180 may integrate an application processor and a modem processor, wherein the application processor may process the operating system, user interface, and application programs, and the modem processor may process wireless communication.

The terminal device 1800 may further include a power supply 1190 (for example a battery), which supplies power to various components. The power supply may be logically connected to the processor 1180 via a power management system so that charging, discharging, power consumption management, and other functions may be realized via the power management system. The power supply 1190 may further include one or more than one DC or AC power supply, a recharging system, a power failure detection circuit, a power converter or inverter, a power status indicator, and other random components. Further, the terminal device 1800 may also include a camera, Bluetooth module, etc., which are not shown in FIG. 18.

Merely for illustration, only one processor is described in the terminal device 1800 that execute operations and/or method steps in the following example embodiments. However, it should be note that the terminal device 1800 in the present disclosure may also include multiple processors, thus operations and/or method steps that are performed by one processor as described in the present disclosure may also be jointly or separately performed by the multiple processors. For example, if in the present disclosure a processor of a terminal device 1800 executes both step A and step B, it should be understood that step A and step B may also be performed by two different processors jointly or separately in the terminal device 1800 (e.g., the first processor executes step A and the second processor executes step B, or the first and second processors jointly execute steps A and B).

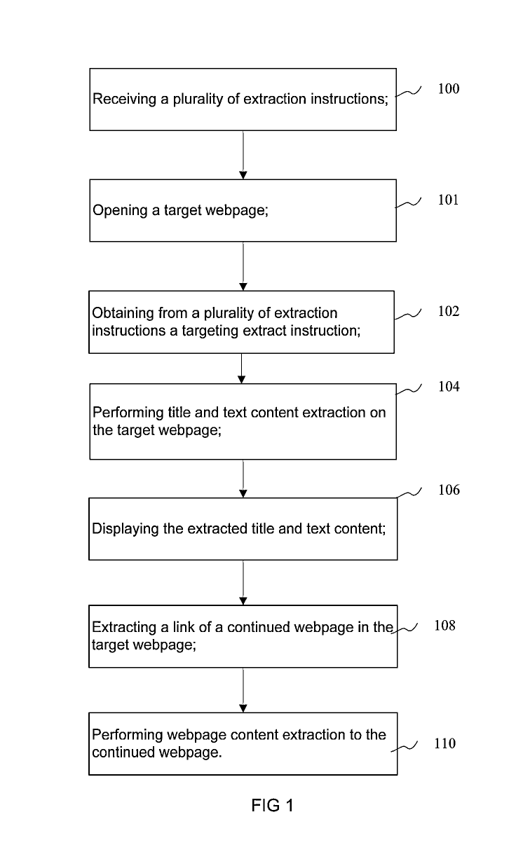

FIG. 1 is a flowchart of a webpage content processing method according to example embodiments of the present disclosure. The method may be implemented in a terminal device, such as the terminal device 1800. The method may include the following steps executed by a processor of the terminal device:

Step 100: Obtaining multiple extraction instructions corresponding to a domain name of a target website, wherein each of the plurality of extraction instruction is configured to direct the terminal device to extract contents of the target website.

Step 101: Opening a target webpage. In this step, the terminal device may open a webpage of the target website. The webpage may be a target webpage that the terminal device is about to extract content therefrom. The target webpage may be in a form of metadata or metafile, or may be in other forms applicable. The target webpage may include a URL and an article or news, which may include a title and a main body of text content.

Step 102: Obtaining a target extraction instruction matching a uniform resource locator (URL) address of the target webpage.

After loading the target webpage, the terminal device then may obtain an extraction instruction that matches a URL address of the target webpage. The terminal device may receive the extraction instruction from a server together with the target webpage, or alternatively, the terminal device may receive the extraction instruction before opening the target webpage.

An extraction instruction may refer to an instruction that can be applied to and executed by the terminal device. For example, the extraction instruction may be an XPath instruction (also referred to as an XPath rule or XPath sentence). XPath is a language for searching an XML (Extensible Markup Language) document for desired information. It navigates through the XML document through an elements and properties of the XML document. Each XPath instruction may include an Internet domain name (i.e., domain name) of a website, a regular expression, and path descriptions of a content block in a webpage (or referred to as XPath of a content block of the webpage). The regular expression may be a sequence of characters that forms a search pattern, mainly for use in pattern matching with strings, or string matching, such as URL string. The regular expression may be configured to match an URL address of a webpage. Thus an extraction instruction may direct the terminal device to perform content extraction on various content blocks of a target webpage.

Because multiple types of websites may exist under a same domain name, and different websites may adopt different XPath, there may have multiple XPath instructions correspond to a single domain name. For example, the domain name qq.com may include a plurality of websites, such as a novel website (novel.qq.com), a news website (news.qq.com), an image website (image.qq.com), a game website (game.qq.com), etc. Each of the plurality of websites may adopt an XPath different from others. Thus to extract the content in each of the plurality of websites, the terminal device may implemented different XPath instructions.

Accordingly, in step 100, to extract contents of webpages in a same domain name, the terminal device may obtain multiple extraction instructions corresponding to a domain name of the target webpage (or a website of the webpage) before step 102. The terminal device may run a browser. Through the browser, the terminal device may access various webpages. After loading a webpage, the terminal device may obtain multiple extraction instructions corresponding to the domain name of the target webpage. For example, the terminal device may directly obtain the multiple extraction instructions corresponding to the domain name of the target webpage from a server of the target webpage, and may also directly obtain the multiple extraction instructions corresponding to the domain name of the target webpage from a local cache of the terminal device.

In step 102, the terminal device may obtain the multiple XPath instructions that correspond to the domain name of the webpage that the terminal device opens, where the XPath instructions may be separated by a first separator. Additionally, path descriptions of the content blocks of different webpages in each XPath instruction may be separated by a second separator. For example, the first separator may be expressed as /t; and the second separator may be expressed as $$. Accordingly, the regular expression of a group of extraction instructions that correspond to webpages of a domain name, such as qq.com, may be:
\t title:xpath$$content:xpath$$content:xpah$$page:xpath . . . ,
   wherein title:xpath is a path description of a title content block, content:xpath is a path description of a text content block, and page:xpath is a path description of a next page block. For example, the content:xpath may be:
content://[@id=“shop738279205”]/div/div/div[2]/div/p[1]/span/span/strong,
   and the terminal device may be configured to extract the corresponding text content on the webpage according to the path description of the text content block in the webpage.

As set forth above, a single domain name may include multiple websites. Each website may have its own extraction instructions, and each website may include multiple webpages. A webpage opened by the terminal device may only be a webpage of one of a plurality of websites under the domain name. Thus after receiving the extraction instructions of the domain name, the terminal device may also need to receive the URL address of the target webpage. The terminal device may use the URL to match with the regular expression in each of the extraction instructions of the domain. The terminal device may determine that the extraction instruction including a regular expression that matches the URL is the extraction instruction (i.e., target extraction instruction) for the target webpage.

Step 104: Performing title and text content extraction to the target webpage according to the path descriptions of the title content block and the text content block.

Because the target extraction instruction includes the path descriptions of the title content block and the text content block on the target webpage, the terminal device may obtain the corresponding title and text content through extraction according to the path descriptions.

Step 106: Displaying the extracted title and text content.

The terminal device may extract the title and text content of the target webpage and erase the rest part of the webpage content (e.g., unrelated pictures, advertisements, etc.), so that only the extracted title and text content is displayed on the target webpage. Content to which the user of the terminal device does not pay attention to may not be displayed in order to save screen space and make the target webpage more convenient for browsing.

According to the example embodiments of the present disclosure, the obtaining of the multiple extraction instructions that correspond to the domain name of the target webpage may further include: detecting whether the multiple extraction instructions exist in a local cache of the terminal device. If yes, obtaining the multiple extraction instructions from the local cache of the terminal device; and if not, obtaining the multiple extraction instructions from a server and saving the multiple extraction instructions in the local cache of the terminal device. According to the example embodiments of the present disclosure, the local cache may be one or more non-transitory, processor-readable, storage media.

The extraction instructions may be saved in the server and may include path descriptions of content blocks of webpages, where the path descriptions may be obtained after the server processes a large amount of websites under different domain names, and may also include an extraction instruction that is set manually and is pre-stored in the server. A correspondence relationship between the domain name and the multiple extraction instructions may be stored in the server.

The multiple extraction instructions corresponding to the domain name of the target webpage may be locally saved in the cache of the terminal device. In this case, the terminal device may first detect whether the multiple extraction instructions exist in the local cache of the terminal device. If yes, the terminal device may not need to obtain them from the server, thereby saving network data traffic; and if not, the terminal device may obtain them from the server and store them in the local cache of the terminal devices, so that the terminal device can directly obtain multiple extraction instructions from the local cache of the terminal device when the terminal device visits the target website again.

Further, the terminal device may preset a predetermined number of domain names from which the terminal device may receive the corresponding extraction instructions. For example, the terminal device may set that it can only receive and store extraction instructions from a maximum of 50 domain names. When the local cache of the terminal device is full, i.e., when the terminal device receives extraction instructions from the 51st domain name, the terminal device may erase extraction instructions from one of the 50 domain names previously received. For example, the terminal may erase the extraction instructions 5 seconds after a browser is activated on the terminal device. For example, the terminal may erase extraction instructions corresponding to a domain name that has not been accessed for more than 7 days 5 seconds after the terminal starts to run the browser.

As such, according to the method, the multiple extraction instructions corresponding to a domain name of a target webpage may be obtained from a local cache of the terminal device, and when an extraction instruction corresponding to domain name exists in the local cache of the terminal device, and the instruction does not need to be obtained from a server, thereby saving network traffic and improving an extraction speed.

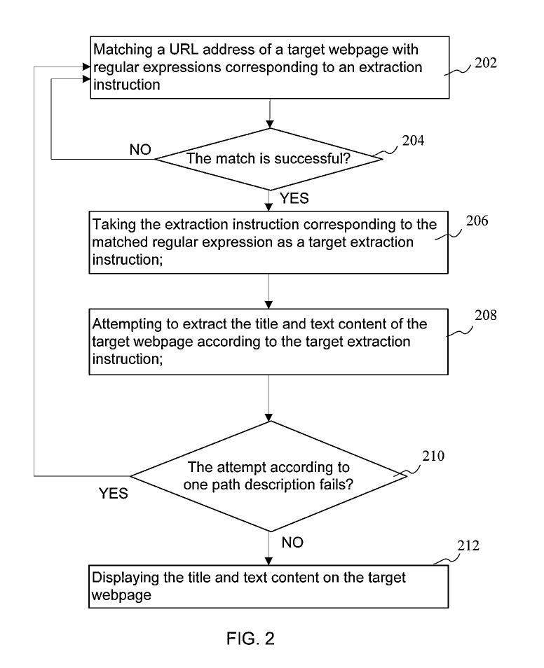

FIG. 2 is a flowchart of a method for obtaining a target extraction instruction according to the example embodiments of the present disclosure. The method may be implemented in a terminal device, such as the terminal device 1800. The method may include the following steps executed by a processor of the terminal device:

Step 202: Matching a URL address of a target webpage with a regular expression corresponding to an extraction instruction.

Step 204: Determining whether the match is successful. If yes, executing step 206; otherwise executing the next extraction instruction and returning to step 202.

Step 206: Taking the extraction instruction corresponding to the matched regular expression as a target extraction instruction.

Step 208: Attempting to extract the title and text content of the target webpage according to path descriptions of title content blocks and text content blocks in the target extraction instruction.

Step 210: Determining whether the extracting attempt according to one path description fails. If yes, go to the next extraction instruction and return to step 202; otherwise executing step 212.

Step 212: Displaying the title and text content on the target webpage.

When the regular expression in the extraction instruction is matched successfully with the URL address of the target webpage, it may indicate that the extraction instruction may be implemented for content extraction on the target webpage. But when the terminal device attempts to perform title and text content extraction according to the path descriptions of title content blocks and text content blocks in the target extraction instruction, if the extraction attempt according to one path description fails, it may indicate that the target extraction instructions actually cannot perform extraction on the target webpage. Thus the terminal device finds a wrong target extraction instruction, and the terminal device may continue to matching the URL address with other extraction instructions until another match is found and the corresponding extraction attempts according to all path descriptions in the newly found target extraction instruction succeed. Further, after the extraction attempt according to all path descriptions succeeded, the terminal device may display a reader button on the target webpage. The actual extraction on the target webpage may be triggered if the user of the terminal device clicks the reader button. After the extraction, the terminal device may compile a CCS (cascading style sheet), and perform re-composition to re-arrange the extracted content from the target webpage into a cleaner layout that is easy to read for the user.

The terminal device may not execute steps 208 to 212 when a corresponding extraction instruction is obtained through matching according to a regular expression, i.e., if the first target extraction instruction is the correct target extraction, then the content extraction may be performed on the target webpage directly without performing steps 208-212.

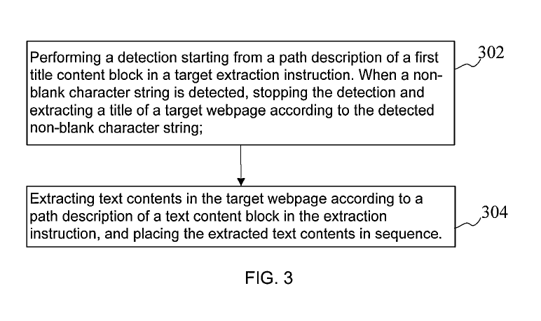

FIG. 3 is a flowchart of a method for extracting title and text content in a target web page according to the example embodiments of the present disclosure. The method may be implemented in a terminal device, such as the terminal device 1800. The method may include the following steps executed by a processor of the terminal device:

Step 302: Performing a detection starting from a path description of a first title content block in a target extraction instruction. When a non-blank character string is detected, stopping the detection and extracting a title of a target webpage according to the detected non-blank character string.

In this step, the terminal device may perform the extraction starting from the path description of the first title content block in the target extraction instruction. When the terminal device detects a non-blank character string, the terminal device may determine that the non-bland character string is the title of the target webpage (i.e., the title of the article on the target webpage) and extract the non-blank character string. This is because the target webpage may only have one title, thus if a non-blank character string is detected, the title can be obtained, and title extraction can be performed on the target webpage according to the detected non-blank character string.

Step 304: Extracting text contents in the target webpage according to a path description of a text content block in the extraction instruction, and placing the extracted text contents in sequence.

Because irrelevant contents (e.g., advertisements) to which the user will not read may exist between text content blocks on the target web page, the text content blocks on the target webpage may not be arranged in sequence and/or in the right order when being extracted. In step 304, the terminal device may extract all the text contents on the target webpage, and place the text contents in the right sequence, so as to obtain all text contents on the target webpage.

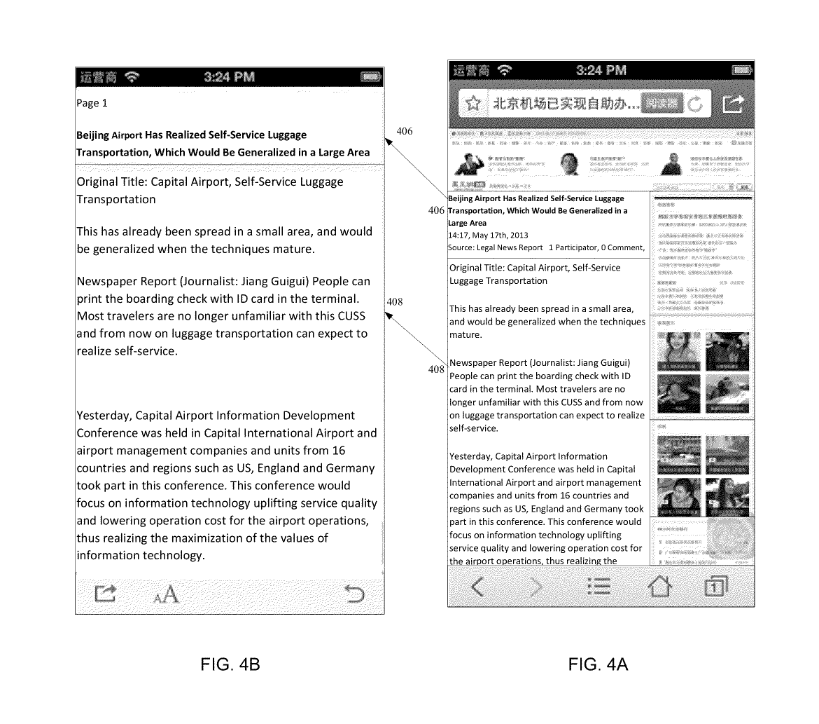

FIG. 4A is an example of a target webpage before content extraction, and FIG. 4B is an example of the target webpage shown in FIG. 4A after extraction. After title and text contents extraction is performed, only the title 406 and text 408 contents may be displayed on the target webpage, and the irrelevant contents to which the user will not pay attention are erased. Therefore, the content extraction method may be implemented to save screen space, and make a webpage more convenient to read, especially when a terminal device (e.g., a mobile phone) has a screen of limited size.

FIG. 5 is a flowchart of a method for removing a dust on a target webpage according to the example embodiments of the present disclosure. According to the method the target extraction instruction may further include a path description of a dust block of a target webpage, and the webpage content processing method may also remove a dust of the webpage, wherein the dust is irrelevant content on the target webpage. The method may be implemented in a terminal device, such as the terminal device 1800. The method may include the following steps executed by a processor of the terminal device:

Step 502: Removing a dust in a target webpage according to a path description of a dust block.

Step 504: Removing a DOM node with a dust tag in the target webpage.

In this method, the terminal device may remove a dust in the target webpage by reconstructing a DOM tree. A dust may be a content or block of content on a webpage that is irrelevant to the main article and/or topic of the webpage, such as ads, so it should be removed from the webpage during the webpage content extraction process disclosed in the present disclosure. A DOM (Document Object Model) is a set of nodes or information segments that are organized in a hierarchical structure, where each node has a property about some information of the node, wherein the property includes a node name, a node value, a node type, etc.

In a process of reconstructing the DOM tree, the dust in the webpage is removed. Because the target extraction instruction may include the path description of the dust block, the terminal device may be able to know and/or determine which nodes among the DOM nodes are dust nodes according to the path description of the dust block. On the other hand, a DOM node may include some tags which can be considered as a dust node, the DOM node with these tags may also be removed by the terminal device. For example, the tag may include, but is not limited to, <script>, <link>, <iframe>, <style>, <form>, <input>, <embed>, and <object>.

In a process of reconstructing the DOM tree, the terminal device may delete the property of each DOM node, but retain the image path property (src property) of an image tag (img tag), the link address property (href property) of a link tag (a tag), and the video path property (src property) of a video tag (video tag). Then the terminal device may re-compile a CCS (cascading style sheet) and perform a re-composition to the layout of the extracted content. As a result, the dusts in the webpage may be removed, while hyperlinks, images, and video clips on the webpage may be retained. One of ordinary skill in the art would understand at the time of the filing of this disclosure that the methods introduced in this disclosure may include at least one step of step 502 and step 504.

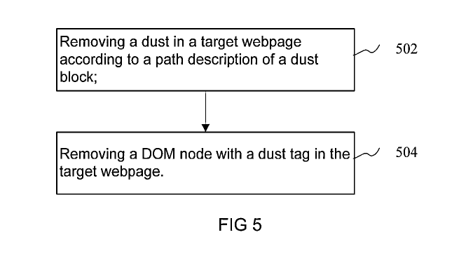

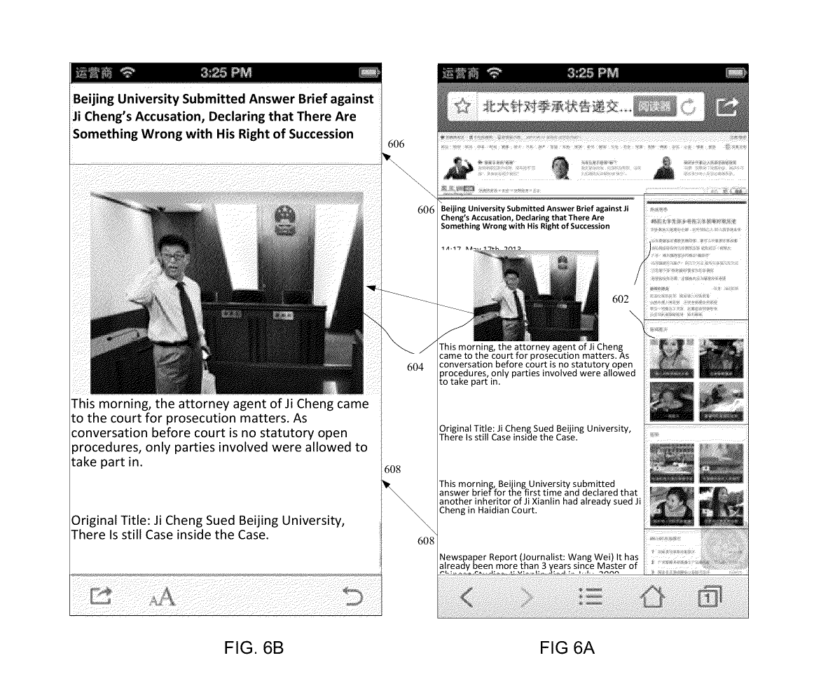

FIG. 6A is an example of a target webpage before content extraction. FIG. 6B is an example of the target webpage shown in FIG. 6A after extraction. In addition to the title and text contents extracted from the target webpage, FIGS. 6A-6B show that the dusts 602 in the webpage may be removed, and an image 604 and a hyperlink may be retained, so that in addition to displaying the title 606 and text 608 contents on the page, the image 604 in the text 608 may also be displayed. The method thereby may further make it convenient for browsing.

It may be understood that, the steps in the foregoing example embodiments may all be executed by the terminal device, such as the terminal device 1800. When an extraction instruction corresponding to a domain name in the target webpage is stored in a local cache of the terminal device, the terminal device may communicate with the cache and execute extraction on the target webpage without being connected to a server. The terminal device will not download the title and text contents again from the server when the user click the reader button and direct the terminal device to show the contents on the webpage. As a result of the extraction, the terminal device may only display the title and text contents (may include the image in the text) on the target webpage, which increases an extraction speed, and saves network data traffic of the terminal device. If the target extraction instruction to the target webpage does not exist in the local cache of the terminal device, the terminal device may only obtain the extraction instruction from the server. Comparing to the title and text content on the webpage, the extraction instruction may have a small amount of data, which may not occupy excessive network data traffic.

Further, the target extraction instruction may include a path description of a page block of a next page next to the target webpage. According to the example embodiments of the present disclosure, the terminal device may automatically conduct context extraction to the next page, i.e., before the user finish reading the target webpage, the terminal device may automatic extract the content of a webpage next to the target webpage that the user may read after finish reading the target webpage. Accordingly, the webpage content processing method may further include:

Step 108: Extracting a link of a continued webpage (i.e., next page) in the target webpage according to the path description of the next page block; and

Step 110: Performing the webpage content processing method in the foregoing embodiments on a webpage corresponding to the next page.

The terminal may obtain a next page link in the target webpage through extraction according to the path description of the next page block. The next page link may correspond to a URL address of a webpage next to the target webpage, and a next webpage of the target webpage may be obtained according to the URL address. The next webpage may be a webpage that has content continues an article in the target webpage, or a webpage having a different article from the article in the target webpage but the user may naturally read after finishing reading the target webpage.

Further, the terminal device may obtain an extraction instruction corresponding to the next webpage through matching extractions of the corresponding domain name with the URL address. After that, the terminal may conduct title and text contents extraction and dust removal according to the matched extraction instruction, by the same methods as introduced above.

According to the example embodiments of the present disclosure, the content extraction operation to the next webpage may be conducted by a server, rather than the terminal device. The server may obtain a next page link, perform extraction on a next page of the target webpage according to the next page link, and then send content obtained through extraction to the terminal device, so that the server does not need to send all content of the next page to the terminal device, thereby saving network data traffic. Alternatively, a terminal device may obtain a next page link, obtain content on the corresponding next webpage delivered by the server, and further perform extraction on the next webpage according to the next page link, so that the extraction of the next webpage is performed by the terminal device, thereby reducing the load of the server.

Because extraction may be automatically implemented on the next page, after a user finishes browsing the title and text content of the currently target webpage, browsing of the next page is triggered, the terminal device may automatically display the title and text content of the next webpage. For example, when a terminal device with a touch screen is used, and when a user finished browsing content of the current page, and uses a finger to perform an upward sliding on the touch screen, content of the next webpage may be automatically displayed and a user does not need to clink a link.

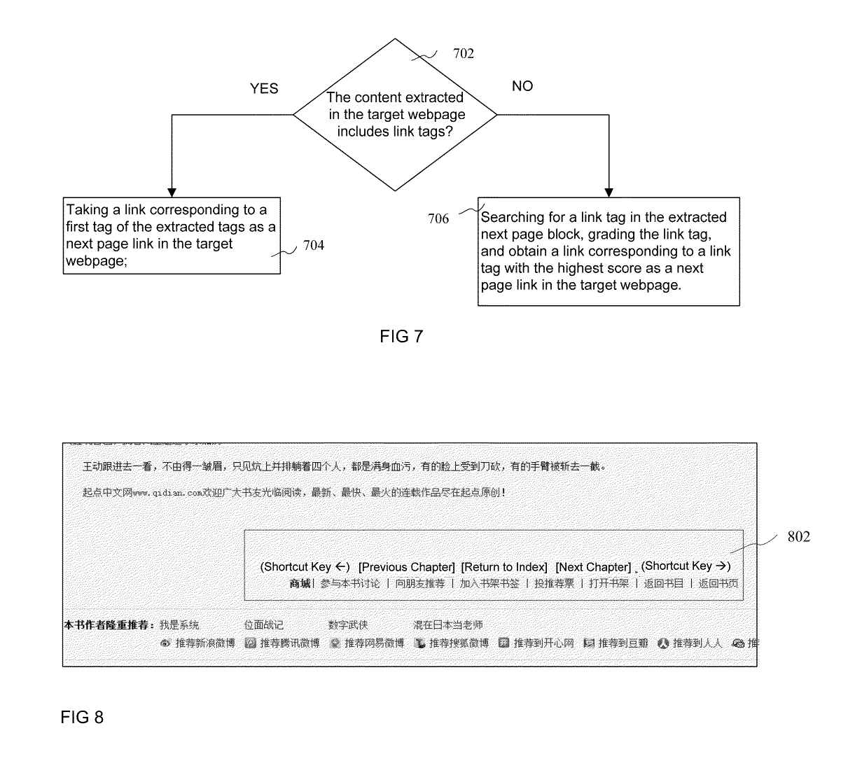

FIG. 7 is a flowchart of a method for extracting a next page link in a target webpage according to the example embodiments of the present disclosure. The method may be implemented in a terminal device, such as the terminal device 1800. The method may include the following steps executed by a processor of the terminal device:

Step 702: Determining whether the content extracted in the target webpage includes link tags. If yes, executing step 704; and otherwise executing step 706.

Step 704: Taking a link corresponding to a first tag of the extracted tags as a next page link in the target webpage.

When link tags are extracted according to a path description of a next page block, the corresponding link may be directly treated as the next page link.

Step 706: Searching for a link tag in the extracted next page block, grading the link tag, and obtain a link corresponding to a link tag with the highest score as a next page link in the target webpage.

When what is extracted according to the path description of the next page block is not a link tag, the terminal device may determine that it is a next page block. As shown in FIG. 8, the next page block 802 may possibly include multiple link tags, such as, “previous chapter”, “next chapter”, and “returning to index”, and the next page link may need to be determined from the multiple link tags.

According to the example embodiments of the present disclosure, step 706 may include: detecting whether the property of a link tag includes preset link content. If yes, grading the link tag according to the preset link content included in the property; and determining whether a link tag with a score greater than zero exists, and if yes, collecting all the links with a link tag score higher than zero and obtaining the link with the highest link tag score as the next page link in the target webpage.

The property of the link tag may include text, title, alt, id, class, etc. The terminal device may detect whether the property includes the preset link content, where the preset link content may be, but is not limited to, “a next page”, “a next chapter”, “a next sheet”, “a next section”, “next”, and “>”. The terminal device may grade the link tags based on the preset link content included in the property. Through the grades, the terminal device may be able to obtain priorities of the preset link content. For example, if the preset link content is “a next page”, the terminal device may add 200 points to the link tag; and if the included preset link content is “a next sheet”, the terminal device may add 180 points to the link tag, so on as so forth. After all the extracted link tags in all next page blocks are graded, the terminal device may determine whether there are a link tags with scores greater than zero, and if yes, the terminal device may determine that the next page link exists, and the link tag with the highest score is selected as the next page link.

According to the example embodiments of the present disclosure, step 706 may further include: if no link tag with a score greater than zero exists, obtaining a sister node of the link tag, scoring the link tag based on the textual content included in the sister node, and detecting whether the link tag includes an image, if yes, adding points to the link tag based on preset text content included in the image; and selecting a link corresponding to the link tag with the highest score as the next page link in the target webpage.

If there is no link tag with a score greater than zero, a sister node of the link tag may be further obtained, that is, obtaining characters before or after the link tag, and preferably the character before the link tag, and then the terminal device may grade the link tag according to these characters. For example, if “a next page” is included, the terminal device may add 100 points to the link tag; if “a next sheet” is included, the terminal device may add 80 points to the link tag, so on and so forth. Further, because some link tags are presented in a form of an image, whether the link tag includes an image may further be detected, if yes, bonus points may be added for the link tag according to whether an image includes “a next page”, “a next sheet”, “a next chapter”, etc. For example, if “next” is included, the terminal device may add 10 points to the link tag; after link tags in all next page blocks are graded, a link corresponding to a link tag with the highest score may be obtained as the next page link in the target webpage.

FIG. 9 is a structural block diagram of a terminal device for executing a webpage processing method according to the example embodiments of the present disclosure. The terminal device may include:

An extraction instruction matching module 904, configured to obtain the target extraction instruction matching a URL address of a target webpage, where the target extraction instruction may include path descriptions of a title content block and a text content block of the target webpage;

A title and text extraction module 906, configured to perform title and text content extraction on the target webpage according to the path descriptions of the title content block and the text content block; and

A displaying module 908, configured to display the extracted title and text content on the target webpage.

The terminal device may further include an extraction instruction obtaining module 902, configured to obtain an extraction instruction corresponding to a domain name of the target webpage.

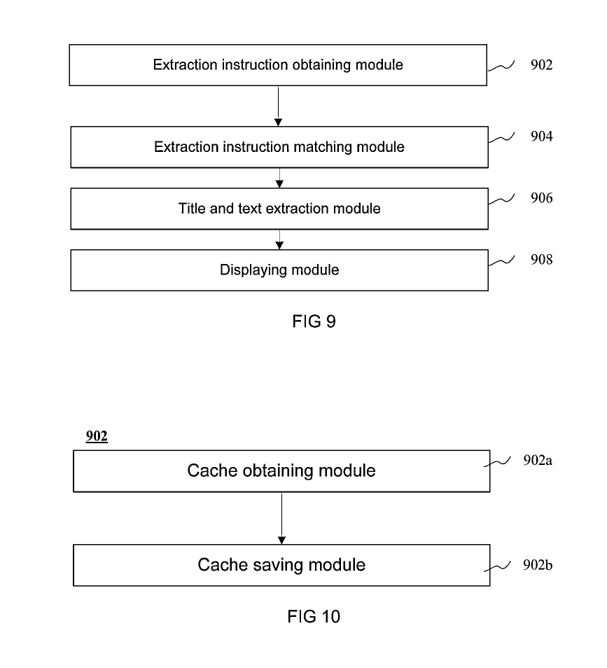

FIG. 10 is a block diagram illustrating the extraction instruction obtaining module in FIG. 9. The extraction instruction obtaining module 902 may include:

A cache obtaining module 902a, configured to detect whether the multiple extraction instructions corresponding to the domain name of the target webpage exist in a local cache of the terminal device, and if yes, obtain the multiple extraction instructions from the local cache; and

A cache saving module 902b, configured to: obtain the multiple extraction instructions from a server and save them in the local cache if the multiple extraction instructions do not exist in the local cache.

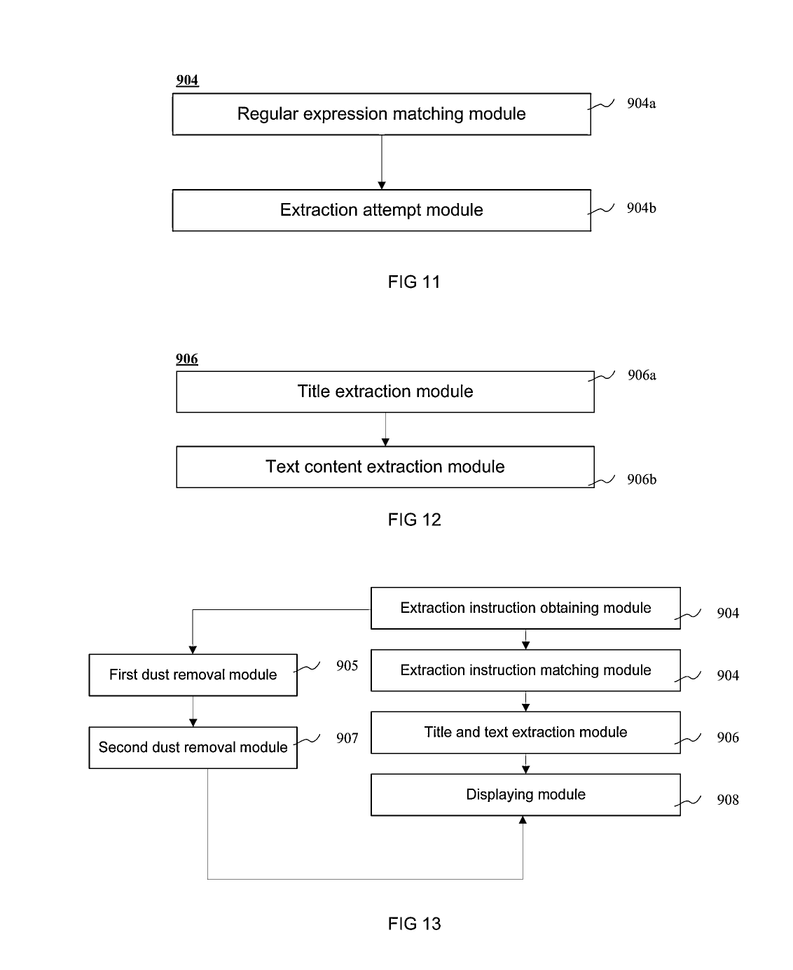

FIG. 11 is a block diagram illustrating an extraction instruction matching module in FIG. 9, the extraction instruction matching module 904 may include:

A regular expression matching module 904a, configured to match a URL address of the target webpage with a regular expression of one of the multiple extraction instructions; and if the match is successful, treat the extraction instruction corresponding to the matched regular expression as the target extraction instruction; and

An extraction attempt module 904b, configured to: attempt to extract the title and text contents of the target webpage according to the path descriptions of the title content blocks and text content blocks in the target extraction instruction, if the matching performed by the regular expression matching module 904a succeeds.

The regular expression matching module 904a may be further configured to: if an extraction attempt according to one path description fails, continue to match the URL address of the target webpage with the regular expression of the next extraction instruction in the multiple extraction instructions to find the next target extraction instruction, until an extraction attempt according to all path descriptions in a target extraction instruction succeed.

The extraction instructions matching module 904 may include at least one of the regular expression matching module 904a and the extraction attempting module 904b.

In an embodiment, as shown in FIG. 12, the title and text extraction module 906 includes:

A title extraction module 906a, configured to perform detection from a path description of a first title content block in the extraction instruction, when a non-blank character string is detected, stop detection, and perform title extraction on the target webpage according to the detected non-blank character string; and

A text content extraction module 906b, configured to extract text content in the target webpage according to the path descriptions of the text content block in the extraction instruction, and place the extracted text content in sequence.

The target extraction instruction may include a path description of a dust block of the target webpage. FIG. 13 is a block diagram illustrating a terminal device for executing a webpage processing method according to the example embodiments of the present disclosure. In addition to the elements in FIG. 9, the terminal device may further include:

A first dust removal module 905, configured to remove a dust in the target webpage according to the path description of the dust block; and

A second dust removal module 907, configured to remove a DOM node with a dust tag in the target webpage.

According to the example embodiments of the present disclosure, the terminal device may include at least one of the first dust removal module 905 and the second dust removal module 907.

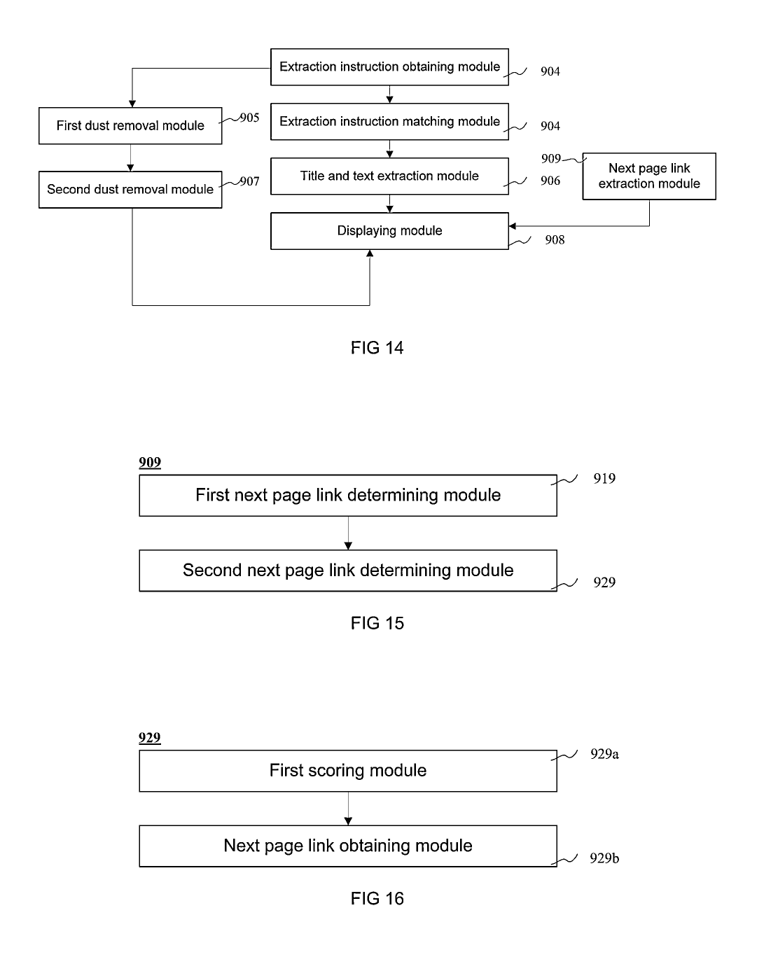

The target extraction instruction may further include a path description of a next page block of the target webpage. FIG. 14 is a block diagram illustrating another terminal device for executing a webpage processing method according to the example embodiments of the present disclosure. In addition to the elements in FIG. 13, the terminal device may further include:

A next page link extraction module 909, configured to extract a next page link in the target webpage according to the path description of the next page block.

In FIG. 14, the extraction instruction matching module 904 may be further configured to extract an extraction instruction matching a URL address corresponding to the next page link according to the URL address corresponding to the next page link; and the title and text extraction module 906 may further be configured to perform title and text content extraction on a webpage corresponding to the next page link according to path descriptions of title content blocks and text content blocks in the matched extraction instruction.

FIG. 15 is a block diagram illustrating the next page link extraction module 909 in FIG. 14. The next page link extraction module 909 may include:

A first next page link determining module 919, configured to: if link tags are extracted, use a link corresponding a first link tag in the extracted link tags as a next page link in the target webpage; and

A second next page link determining module 929, configured to: if no link tag is extracted, search for a link tag in the extracted next page block, grade the link tag, and obtain a link corresponding to a link tag with the highest score as a next page link in the target webpage.

FIG. 16 is a block diagram illustrating a second next page link determining module in FIG. 14. The second next page link determining module 929 may include:

A first scoring module 929a, configured to detect whether a preset link content is included in the property of the link tag, and if yes, add predetermined points to the link tag according to the preset link content included in the property; and

A next page link obtaining module 929b, configured to determine if there are any link tags with tag scores greater than zero, and if yes, selecting the link corresponding to a link tag with the highest score as the next page link in the target webpage.

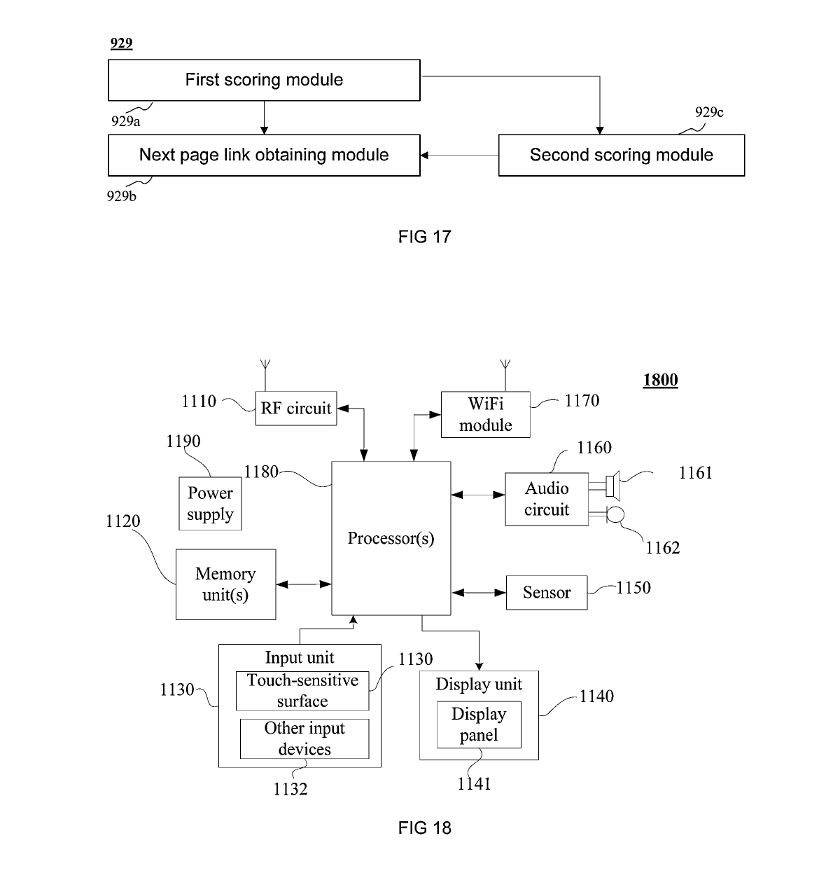

FIG. 17 is block diagram illustrating another second next page link determining module according to the example embodiments of the present disclosure. In addition to all the elements shown in FIG. 16, the second next page link determining module 929 may further include:

A second bonus score adding module 929c, configured to: if no link tag with a score greater than zero exists, obtain a sister node of the link tag, add predetermined points to the link tag based on the textual and/or character content included in the sister node, detect whether the link tag includes an image, and if yes, add predetermined points to the link tag according to preset text content included in the image.

In FIG. 17, the next page link obtaining module 929b may be further configured to obtain a link corresponding to the link tag with the highest score as the next page link in the target webpage.

It may be understood by a person of ordinary skill in the art that all or a part of the procedures of the methods in the foregoing embodiments may be implemented by a computer program configured to executed by corresponding hardware. The program may be stored in a computer readable storage medium. When the program is run, procedures of the foregoing methods may be executed. The storage medium may be a magnetic disk, an optical disc, a read-only memory (Read-only Memory, ROM), or a random access memory (Random Access Memory, RAM), etc.

Further, the terminal device 1800 in FIG. 18 may also implement the above methods for webpage processing and serve as an apparatus configured to executing the same. For convenience of description, the terminal device 1800 may be any terminal device, such as a phone, a tablet computer, a PDA (Personal Digital Assistant, personal digital assistant), a POS (Point of Sales, point of sales), or a car-mounted computer, and that the terminal device is the phone is used as an example.

In addition to the features introduced at the beginning of the present disclosure, the processor 1180 in the terminal device 1800 may also be configured to perform the following functions: obtaining a target extraction instruction matching a URL address of a target webpage, where the target extraction instruction may include path descriptions of a title content block and a text content block of the target webpage; performing title and text content extraction on the target webpage according to the path descriptions of the title content block and the text content block; and displaying the extracted title and text content.

The processor 1180 may also be configured to perform the following function: obtaining multiple extraction instructions corresponding to a domain name of the target webpage.

The processor 1180 may also be configured to perform the following functions: matching the URL address of the target webpage with regular expressions corresponding to an extraction instruction of the multiple extraction instructions; and if the match is successful, using an extraction instruction corresponding to the matched regular expression as the target extraction instruction.

The processor 1180 may also be configured to perform the following functions: if the match is successful, attempting to extract title and text content of the target webpage according to the path descriptions of the title content block and the text content block of the target extraction instruction; and if an extraction attempt according to one path description fails, continuing to match the URL address of the target webpage one by one with regular expressions corresponding to another extraction instruction of the multiple extraction instructions until extraction attempts according to all path descriptions in the target extraction instruction succeed.

The processor 1180 may also be configured to perform the following functions: performing detection from a path description of a first title content block in the extraction instruction, when a non-blank character string is detected, stopping the detection, and performing title extraction on the target webpage according to the detected non-blank character string; and extracting text content in the target webpage according to the path description of the text content block in the extraction instruction, and placing the extracted text content in sequence.

The target extraction instruction may further include a path description of a dust of the target webpage, and the processor 1180 may also be configured to perform the following function: removing a dust in the target webpage according to the path description of the dust block.

The processor 1180 may also be configured to perform the following function: removing a DOM node with a dust tag in the target webpage.

Additionally, the target extraction instruction may further include a path description of a next page block of the target webpage, and the processor 1180 may also be configured to perform the following functions: extracting a next page link in the target webpage according to the path description of the next page block; and executing the webpage content processing method on the webpage corresponding to the next page link.

The processor 1180 may also be configured to perform the following functions: if link tags are extracted, using a link corresponding to a first link tag in the extracted link tags as a next page link in the target webpage; if no link tag is extracted, searching for the link tag in the extracted next page block, grading the link tag, and obtaining a link corresponding to a link tag with the highest score as the next page link in the target webpage.

The processor 1180 may also be configured to perform the following functions: detecting whether preset link content exists in the property of the link tag, if yes, adding predetermined points to a score of the link tag according to the preset link content included in the property; and determining whether a link tag with a score greater than zero exists, if yes, selecting the link corresponding to the link tag with the highest score as the next page link in the target webpage.

The processor 1180 may also be configured to perform the following functions: if no link tag with a score greater than zero exists, obtaining a sister node of the link tag, adding predetermined points to the score of the link tag according to character content included in the sister node, detecting whether an image is included in the link tag, and if yes, adding a bonus score for the link tag according to preset text content included in the image; and obtaining a link corresponding to a link tag with the highest score as the next page link in the target webpage.

The processor 1180 may also be configured to perform the following functions: detecting whether multiple extraction instructions corresponding to the domain name of the target webpage exists in a local cache of the terminal device 1800, if yes, obtaining the multiple extraction instructions corresponding to the domain name of the target webpage from the local cache, and if not, receiving the multiple extraction instructions from a server and store them in the local cache.

While example embodiments of the present disclosure relate to apparatuses and methods for webpage content processor, the apparatuses and methods may also be applied to other Applications. The present disclosure intends to cover the broadest scope of systems and methods for content browsing, generation, and interaction.

Thus, example embodiments illustrated in FIGS. 1-18 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

What is claimed is:

1. A method for processing webpage content processing, the method comprising:
providing a terminal device including at least one processor;
opening, via said at least one processor, a target webpage on the terminal device,
wherein the target page includes a plurality of title content blocks and a plurality of text content blocks;
obtaining, via said at least one processor, a target extraction instruction, wherein the target extraction instruction:
is configured to match with a uniform resource locator (URL) address of the target webpage, and
includes a path description of the plurality of title content blocks and a path description of the plurality of text content blocks of the target webpage configured to direct the at least one processor to extract content of the target webpage;
extracting, by the at least one processor, a title and text content from the target webpage according to the path description of the title content block and the path description of the text content block; and
displaying, the extracted title and text content on the terminal device.

2. The method according to claim 1, wherein the obtaining of the target extraction instruction comprises:
selecting an extraction instruction from a plurality of extraction instructions as a candidate extraction instruction,
wherein the plurality of extraction instructions is associated with an Internet domain name of the target webpage, and
wherein each of the plurality of extraction instructions includes a regular expression that identifies a URL address that the extraction instruction applies to;
matching the URL address of the target webpage with the regular expression of the candidate extraction instruction; and when the URL address of the target webpage matches with the regular expression of the candidate instruction,
selecting the candidate extraction instruction as the target extraction instruction; and
extracting the title and text content of the target webpage according to the path description of the plurality of title content blocks and the path description of the plurality of text content blocks in the target extraction instruction.

3. The method according to claim 2, wherein the obtaining of the target extraction instruction further comprises:
when the URL address of the target webpage does not match with the regular expression of the candidate instruction, or when the extracting of the title and text content of the target webpage fails,
continually selecting another extraction instruction from the plurality of extraction instructions as a candidate extraction instruction; and
matching the URL address of the target webpage with the regular expression of the candidate extraction instruction until another target candidate extraction instruction is obtained.

4. The method according to claim 1, wherein the extracting of the title content on the target webpage comprises:
detecting a non-blank character string from a path description of a title content block of the plurality of title content blocks;
extracting the non-blank character string as the title content of the target webpage; and
wherein the extracting of the text content on the target webpage comprises:
extracting the text content of the target webpage according to the path description of the plurality of text content blocks, and
placing the extracted text content in sequence.

5. The method according to claim 1, wherein the target extraction instruction further comprises a path description of a plurality of dust blocks of the target webpage; and
the method further comprising at least one of:
removing, by the at least one processor, content of the target webpage according to the path description of the plurality of dust blocks; and
removing, by the at least one processor, a node associated with a dust tag in a Document Object Model of the target webpage.

6. The method according to claim 1, wherein the target webpage further comprises a next page block;
wherein the target extraction instruction further comprises a path description of the next page block on the target webpage; and
the method further comprising:
extracting, by the at least one processor, a next page link from the target webpage according to the path description of the next page block; and
performing, by the at least one processor, a webpage content extraction on a webpage corresponding to the next page link before receiving an instruction to obtain the webpage content extraction.

7. The method according to claim 6, wherein the next page block comprises at least one link and at least one link tag associated with the at least one link;
wherein the extracting of the next page link in the target webpage according to the path description of the next page block comprises:
when the at least one processor extracts the plurality of link tags from the target webpage,
selecting the first link tag being extracted from the plurality of link tags as the next page link in the target webpage
obtaining a link corresponds to the first link tag as the next page link of the target webpage.

8. The method according to claim 6, wherein the next page block comprises at least one link and at least one link tag associated with the at least one link;
wherein the extracting of the next page link in the target webpage according to the path description of the next page block comprises:
when the at least one processor extracts no link tag,
searching for the at least one link tag from the extracted next page block,
scoring each of the at least one link tag; and
obtaining a link corresponding to a link tag having the highest score among the at least one link tag as the next page link in the target webpage.

9. The method according to claim 8, wherein the at least one link tag comprises a property including a preset link content,
the method further comprising,
increasing the score of the link tag according to the preset link content; and
when one or more link tags have a score greater than zero, obtaining a link corresponding to a link tag with the highest score among the at least one link tag as the next page link in the target webpage.

10. The method according to claim 9, further comprising, when no link tag in the at least one link tag has a score greater than zero,
for each of the at least one link tag,
obtaining a sister node for the link tag,
increasing the score of the link tag according to character content in the sister node,
when the link tag includes an image, increasing the score of the link tag according to preset text content in in the image; and
obtaining a link corresponding to a link tag having the highest score among the at least one link tag as the next page link in the target webpage.

11. An apparatus, comprising:
at least one non-transitory processor-readable storage medium including at least one set of instructions for webpage content processing; and
at least one processor in communication with the at least one storage medium, the at least one processor being configured to execute the at least one set of instructions to:
open a target webpage on the terminal device,
wherein the target page includes a plurality of title content blocks and a plurality of text content blocks;
obtain a target extraction instruction, wherein the target extraction instruction:
is configured to match with a uniform resource locator (URL) address of the target webpage, and
includes a path description of the plurality of title content blocks and a path description of the plurality of text content blocks of the target webpage configured to direct the at least one processor to extract content of the target webpage;
extract a title and text content from the target webpage according to the path description of the title content block and the path description of the text content block; and
display the extracted title and text content on the terminal device.

12. The apparatus according to claim 11, wherein to obtain the target extraction instruction the at least one processor is configured to execute the at least one set of instructions to:
select an extraction instruction from a plurality of extraction instructions as a candidate extraction instruction,
wherein the plurality of extraction instructions is associated with an Internet domain name of the target webpage, and
wherein each of the plurality of extraction instructions includes a regular expression that identifies a URL address that the extraction instruction applies to;
match the URL address of the target webpage with the regular expression of the candidate extraction instruction;
when the URL address of the target webpage matches with the regular expression of the candidate instruction,
select the candidate extraction instruction as the target extraction instruction; and
extract the title and text content of the target webpage according to the path description of the plurality of title content blocks and the path description of the plurality of text content blocks in the target extraction instruction.

13. The apparatus according to claim 12, wherein to obtain the target extraction instruction the at least one processor is configured to execute the at least one set of instructions to:
when the URL address of the target webpage does not match with the regular expression of the candidate instruction, or when the extracting of the title and text content of the target webpage fails,
continually select another extraction instruction from the plurality of extraction instructions as a candidate extraction instruction; and
match the URL address of the target webpage with the regular expression of the candidate extraction instruction until another target candidate extraction instruction is obtained.

14. The apparatus according to claim 11, wherein to extract the title content in the target webpage the at least one processor is configured to execute the at least one set of instructions to:
detect a non-blank character string from a path description of a title content block of the plurality of title content blocks;
extract the non-blank character string as the title content of the target webpage; and
wherein the extracting of the text content on the target webpage comprises:
extract the text content of the target webpage according to the path description of the plurality of text content blocks, and
place the extracted text content in sequence.

15. The apparatus according to claim 11, wherein the target extraction instruction further comprises a path description of a plurality of dust blocks of the target webpage; and
the at least one processor is further configured to execute the at least one set of instructions to conduct at least one of:
removing content of the target webpage according to the path description of the plurality of dust blocks; and
removing a node associated with a dust tag in a Document Object Model of the target webpage.

16. The apparatus according to claim 11, wherein the target webpage further comprises a next page block;
wherein the target extraction instruction further comprises a path description of the next page block on the target webpage; and
wherein the at least one processor is further configured to execute the at least one set of instructions to:
extract a next page link from the target webpage according to the path description of the next page block; and
perform a webpage content extraction on a webpage corresponding to the next page link before receiving an instruction to obtain the webpage content extraction.

17. The apparatus according to claim 16, wherein the next page block comprises at least one link and at least one link tag associated with the at least one link;
wherein to extract the next page link in the target webpage according to the path description of the next page block, the at least one processor is configured to execute the at least one set of instructions to:
when the at least one processor extracts the plurality of link tags from the target webpage,
select the first link tag being extracted from the plurality of link tags as the next page link in the target webpage
obtain a link corresponds to the first link tag as the next page link of the target webpage.

18. The apparatus according to claim 16, wherein the next page block comprises at least one link and at least one link tag associated with the at least one link;
wherein to extract the next page link in the target webpage according to the path description of the next page block, the at least one processor is configured to execute the at least one set of instructions to:
when the at least one processor extracts no link tag,
search for the at least one link tag from the extracted next page block,
score each of the at least one link tag; and
obtain a link corresponding to a link tag having the highest score among the at least one link tag as the next page link in the target webpage.

19. The apparatus according to claim 18, wherein the at least one link tag comprises a property including a preset link content; and
wherein the at least one processor is further configured to execute the at least one set of instructions to,
increase the score of the link tag according to the preset link content; and
when one or more link tags have a score greater than zero, obtain a link corresponding to a link tag with the highest score among the at least one link tag as the next page link in the target webpage.

20. The apparatus according to claim 19, wherein the at least one processor is further configured to execute the at least one set of instructions to, when no link tag in the at least one link tag has a score greater than zero,
for each of the at least one link tag,
obtain a sister node for the link tag,
increase the score of the link tag according to character content in the sister node,
when the link tag includes an image, increase the score of the link tag according to preset text content in in the image; and
obtain a link corresponding to a link tag having the highest score among the at least one link tag as the next page link in the target webpage.
